(19) United States
(12) Patent Application Publication
(10) Pub. No.: US 2022/0321662 A1
(43) Pub. Date: Oct. 6, 2022

(54) SMART DEVICE RESPONSE TO EVENT DETECTION

(71) Applicant: International Business Machines Corporation, Armonk, NY (US)

(72) Inventors: Prathima Maskeri, Chantilly, VA (US); Ruchi Mahindru, Elmsford, NY (US); Vittorio Castelli, Croton-on-Hudson, NY (US)

(21) Appl. No.: 17/217,748

(22) Filed: Mar. 30, 2021

(51) Int. Cl. H04L 29/08; G06N 3/04; G16Y 40/10; G16Y 20/10; H04W 4/02

(52) U.S. Cl. CPC H04L 67/125; G06N 3/04; G16Y 40/10; G16Y 20/10; H04W 4/02

(57) ABSTRACT

An approach to controlling smart devices in response to detecting events may be provided. The location data of a user may be received, along with date and time for the location data. The location may be compared to a daily schedule to determine whether an event has occurred. If the location data is determined to be outside of the daily schedule it is determined an event has occurred. The event is then compared to other logged events within a historical event database, to determine if the event is similar to any past events. If the event is determined to be similar to a past event, the state of smart devices connected to an event driven smart device control environment are changed to mirror the state they were in at during determined similar event.

### BACKGROUND OF THE INVENTION

The present invention relates generally to the field of smart device scheduling, more specifically, detecting events and changing smart device state in response.

Smart devices or appliances that can connect to a network have allowed for users to control the connected smart appliance with a smart phone from virtually anywhere. In many cases security systems, door locks, appliances, printers, lights, and kitchen appliances can all be connected wirelessly allowing for easy, seemingly unlimited control of the smart devices. This control is typically performed via an app or on a browser on a user's smart device such as a phone, tablet, and/or computer. Smart devices can also be controlled by a static or semi-static schedule. In many cases the schedule can be input by a user or be configured by the manufacturer if the user chooses. Further, some devices may prompt a user, via a set reminder, to enable an appliance or change the state of a smart device within the home.

### SUMMARY

Embodiments of the present disclosure include a computer-implemented method, computer program product, and a system for changing a smart appliance state in response to detecting an event. Embodiments may comprise identifying an event based on at least location data associated with a user's device; determining, by the processor, whether the event is outside of a user's daily schedule; determining, by the processors, whether the event is similar to one or more prior events based on an interconnected device event response model; responsive to the event being outside of the daily schedule and the event being similar to one or more prior events; and changing, by the processors, a state of one or more smart appliances to a state corresponding to the one or more similar prior events.

The above summary is not intended to describe each illustrated embodiment of every implementation of the present disclosure.

### BRIEF DESCRIPTION OF THE DRAWINGS

FIG. 1 is a functional block diagram generally depicting an event driven smart device control environment, in accordance with an embodiment of the present invention.

FIG. 2 is a flowchart depicting method for changing smart appliance state in response to detecting an event, in accordance with an embodiment of the present invention.

FIG. 3 is a functional block diagram of an exemplary computing system within an event driven smart device control environment, in accordance with an embodiment of the present invention.

FIG. 4 is a diagram depicting a cloud computing environment, in accordance with an embodiment of the present invention.

FIG. 5 is a functional block diagram depicting abstraction model layers, in accordance with an embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The embodiments depicted allow for event driven control of smart devices. In an embodiment, an event is identified from location data associated with a user's smart device and the time corresponding to the location data. Based on the location and corresponding time it can be determined if the event is outside of the daily schedule of the user. If it is determined the event is outside the daily schedule of the user, the event can be compared to other events within a historical event pool. If the event is determined to be similar to an event within the historical event pool, the state of a smart appliance or device can be changed based on the response of the event determined to be similar.

Embodiments of the current invention have many improvements over current technologies. Most smart devices have static schedules that are unable to predict or change in response to unforeseen events. For example, if a thermostat is set to increase the temperature just prior to a person returning home from work and the person makes a detour and arrives home three hours later than normal, the heat does not need to be turned up until two hours prior to the person returning home. Embodiments, of the current invention allow for the location of the user to be determined and the schedule of smart devices to be changed dynamically in response to an unforeseen change in the daily schedule of the user.

A preferred embodiment of the current invention allows for an event detection control engine to monitor a user's location via an app downloaded onto a smart phone with the user's permission. The user has subscribed to the service and provided a profile including information regarding their daily schedule. The event detection control engine has machine learning abilities and can further build out the daily schedule of the user and the state of smart devices within the user's home or place of employment. The user's location is further monitored and if it is determined the user is at a location outside of the generated daily schedule, it is determined an event has occurred. The event is compared to other events detected by the event detection control engine to determine if a similar event has occurred. Once a similar event has been identified, the state of smart devices registered with the service are changed to mirror the state of the devices during the similar event.

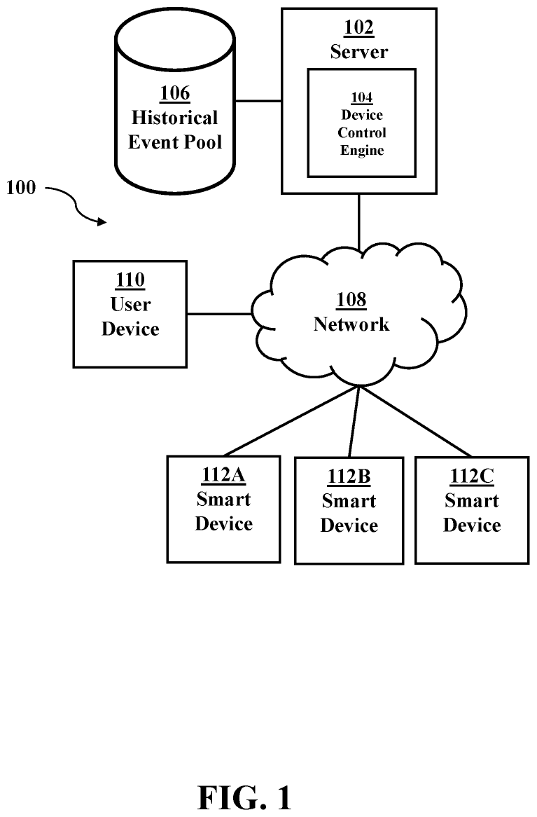

FIG. 1 is a functional block diagram generally depicting an event driven smart device control environment 100. Event driven smart device control environment 100 comprises device control engine 104 operational on server 102 and historical event pool 106 stored on server 102, user device 110, smart devices 112A, 112B, 112C, interconnected over network 108.

Server 102 can be a standalone computing device, a management server, a web server, a mobile computing device, or any other electronic device or computing system capable of receiving, sending, and processing data. In other embodiments, server 102 can represent a server computing system utilizing multiple computers as a server system. In another embodiment, server 102 can be a laptop computer, a tablet computer, a netbook computer, a personal computer, a desktop computer, or any programmable electronic device capable of communicating with other computing devices within event driven smart device control environment 100 via network 108.

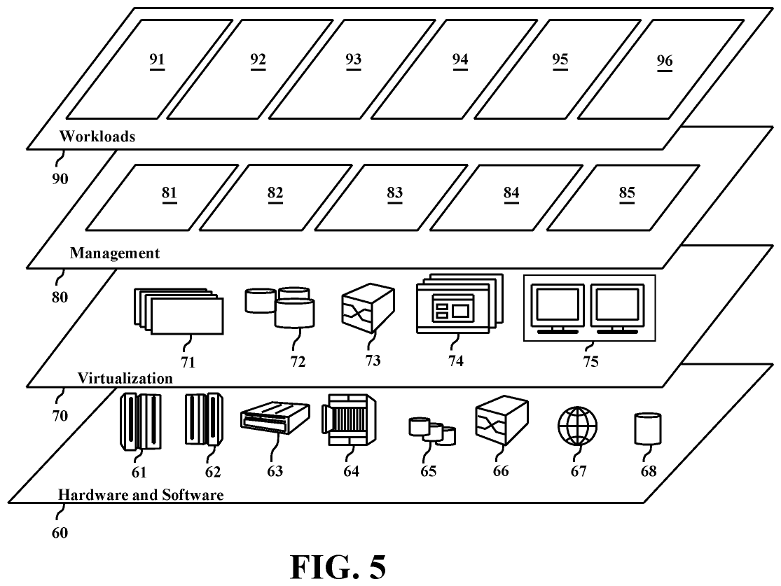

In another embodiment, server 102 represents a computing system utilizing clustered computers and components (e.g., database server computers, application server computers, etc.) that can act as a single pool of seamless resources when accessed within event driven smart device control environment 100. Server 102 can include internal and external hardware components, as depicted and described in further detail with respect to FIG. 5. It should be noted, while only Server 102 is shown in FIG. 1, multiple computing devices can be present within event driven smart device control environment 100. In an example, server 102 can be a part of a cloud server network in which a computing device (not shown) connected to network 108 can access server 102 (e.g., the internet).

The device control engine 104 is a computer module that can be configured to detect an event outside of the daily schedule of a user and change the state of a smart device. In an embodiment, device control engine 104 can receive or retrieve the location of a user's device that is registered with device control engine 104. Device control engine 104 can use the location data from the user's device to build a daily schedule for the user. A daily schedule can be the location where the user is expected to be at a given time. The daily schedule can change from day-to-day or week-to-week (explained further below). Additionally, smart devices or services that control smart devices may be registered with device control engine 104 and allow for device control engine 104 to change the state of smart devices.

In some embodiments, device control engine 104 may be associated with a subscription or service platform, which a user registers a smart device, smart appliance, security system, etc. . . . . A user may input information that assists in building a daily schedule. For example, a user may input the address of their employer or school and the hours which the user is regularly at that location. Further, a user may input the location (e.g., address or map point location) of normal recreational activities. Additionally, the user may input preferences associated with smart device states. For example, the user may input a thermostat schedule, security system settings, light settings, etc. . . . .

In an embodiment, device control engine 104 can learn the daily schedule of a user based on the location of user device 110 and the state of smart devices 112A, 112B, and 112C. For example, device control engine 104 can use a machine learning model to monitor user device 110 location and manual inputs of the user into smart devices. The machine learning model can generate a rule set incorporating any user preferences, manual inputs into a smart device, and user device 110 location.

In some embodiments, device control engine 104 may be associated with an orchestration service of smart appliances or security systems. For example, a user may have multiple brands of smart appliance, which operate on different applications or web sites. Device control engine 104 can be configured to access each smart appliance application and monitor the state of each smart appliance. In another example, device control engine 104 may be granted access by the user to a security system control center, which may include door and window locks, cameras, motion detectors, on/off switches, etc. Device control engine 104 can be configured to access and control the security system components through the control center. Additionally, in an embodiment, if a user does not bring user device 110 with them, device control engine 104 may monitor the security system to detect if the user is home. For example, if the security system has motion detectors, device control engine 104 can determine if there is motion in the home. Device control engine 104 can also be configured to determine if user device 110 is moving by its location services and/or accelerometers within user device 110.

In another embodiment, device control engine 104 may be a cloud based service with an accompanying smart device app for a smart phone or tablet and web browser access. For example, a user can download an app to their smart phone. The app can allow device control engine 104 to monitor or retrieve user's location data via the smart phone's global positioning system, Bluetooth®, or Near Field Communication capabilities. Additionally, the smart device app can allow for two-factor authentication capabilities, if a security system is associated with the cloud based service. In some embodiments, device control engine 104 may be configured to send a prompt regarding a detected event in instances where the event is not similar to another event within historical event pool 106.

Historical event pool 106 is a database that can be configured to store location data associated with a user. In some embodiments, device control engine 104 can receive location data from one or more user's smart devices. Further, historical event pool 106 can store vector embeddings associated with detected events. In some embodiments, historical event pool 106 can store the state of smart devices or applications and the corresponding time and date. Additionally, in some embodiments, historical event pool 106 may store weather and climate data associated with a detected event.

In some embodiments, device control engine 104 can be configured with an event detection capability. The event detection capability can be associated with a platform which a user inputs information associated with the user profile. The user profile may have information relating to the user's normal daily routine. For example, the user may have children that participate in recreational activities in the evenings and on weekends. The user may input information such as practices, games, recitals, and other activities into a calendar, or the user may provide permissions for device control engine 104 access to an online calendar with the events.

In another embodiment, device control engine 104 may be configured with an interconnected device event response model. Interconnected device event response model can be a deep neural network (e.g., long short-term memory (“LSTM”), Bidirectional Encoding representations from Transformers (“BERT”) . . . ). Interconnected device event response model can be used to classify events based on the user device 110 location data for the given time and date. Further, encodings can be created for each detected event and stored in historical event pool 106. Additional factors may be fed into the interconnected device event response model. These factors may include, weather, the user's social media feed, local news feeds, and the location of other user's associated with the profile of the user on device control engine 104. For example, if it is detected the user is on a different road than normal after work and the weather is currently thunderstorms, interconnected device event response model can generate a vector embedding with the pertinent information. Further, device control engine 104 may receive a report from a local news feed that a local highway has flooded or been shut down. This may also be factored into the vector embedding for the event.

In an embodiment, device control engine 104 may be able to learn the daily schedule of a user. Device control engine 104 with an interconnected device event response model may be trained to generate contextual embeddings for events. Event types (e.g., user location, user arrival time, user departure time, etc.) may be defined within a dictionary. The possible locations for an event may be defined within a dictionary. Time of events may be defined within a dictionary. All of the dictionary entries are assigned a value. The value corresponds to a vector, which can be a floating point number. The embedding vectors of the event is a concatenation of vectors (e.g., [event type][location][time][other parameters]). The dictionary entries can be stored in historical event pool 106. Previously recorded events can be input into a deep neural network (e.g., BERT) to pretrain the network allowing for the output of contextual embeddings. Contextual embeddings can show the association between events via the vectors of the contextual embeddings. Further, once the interconnected device event response model is trained to output contextual embeddings, device control engine 104 can learn the daily schedule of the user and dynamically make modifications to the daily schedule based on location of the user device and any manual inputs into smart device 112A, 112B, 112C.

Device control engine 104 may compare the generated vector embeddings to the embeddings of other events within historical event pool 106. In some cases, a similarity score may be calculated for the generated vector embedding. The similarity score can be compared to a threshold score. If the similarity score for an event is above the threshold score for multiple events, the event with the highest similarity score will be assigned to the generated event. Further, device control engine 104 can send a signal to smart device 112A, 112B, 112C to be in the same state as in the determined similar event. For example, a user's device leaves work at 11:30 P.M. on a Saturday evening, during fair weather, rather than the normal 8:00 P.M. Device control engine 104 generates an embedding and determines it is similar to an event. The similar event had a home security system change of state where outdoor lights were left off upon the user's approach, and the smart lock in the garage required the user to input a pass key to enter the home, rather than opening when detecting the NFC of user device 110. In this example, device control engine 104 changes the state of the home security system to the same as the assigned similar event.

In some embodiments, if an event is detected, but does not reach a threshold similarity score, the event with the highest similarity score can be assigned to the event and a prompt can be sent to user device 110, asking if the user would like the state of smart devices to match those of the assigned event.

Network 108 can be a local area network (LAN), a wide area network (WAN) such as the Internet, or a combination of the two, and can include wired, wireless, or fiber optic connections. In general, network 108 can be any combination of connections and protocols that will support communications between servers 102, user device 110 and smart device 112A, 112b, and 112C.

User device 110 can be a computing device that can send and receive location data. In an embodiment, user device 110 is a smart phone with GPS capabilities. For example, a user may download an app to their smart phone and allow device control engine 104 to monitor the GPS activity of user device 110. It should be noted, the term GPS is used for simplicity as some embodiments may use cellular phone tower triangulation or other methods of determining the location of user device 110. In another embodiment, user device 110 may be configured to connect to a local wi-fi network and provide location data via internet protocol address or have an enabled cellular network, allowing device control engine 104 to monitor or receive location data from user device 110. In another embodiment, user device 110 can be a smart device, such as a smart watch, smart wearable device, smart glasses, or the like, provided the device can download an app which can connect to device control engine 104 or be registered to a platform which hosts device control engine 104.

It should be noted, while only one user device 110 is shown in FIG. 1, more than one user device can be within event driven smart device control environment 100. In a preferred embodiment, only one user will be registered to a user device 110. In some embodiments, if more than one user is registered to a user device 110, a user may inform device control engine 104 which user is using a device, via changing the user profile within an app on user device 110.

In some embodiments, event driven smart device control environment 100 can have multiple users (2, 3, n . . . n+1) each with a user device 110 registered to an individual user providing location data. In some embodiments, device control engine 104 can use the location and corresponding time of multiple users to determine if an event has occurred and predict the correct response of smart device 112A, 112B, 112C based on the location of multiple user devices.

In an embodiment, multiple users with different subscription accounts from different households can be within event driven smart device control environment 100. In such an embodiment, device control engine 104 can be located on server 102 within a cloud based subscription service. Device control engine 104 can monitor the location of multiple users and build a knowledge base of the state of smart devices (not shown) registered to the multiple users, based on the daily schedule for the multiple users. For example, when it is cold outside, people tend to turn the thermostat down (e.g., 65 degrees) when they leave their homes for work or school and turn it back up (e.g., 70 degrees). Device control engine 104 would detect the state change of the smart thermostats across multiple households and the location change of the user devices 110. This information from multiple subscriber households can be associated with the daily schedule of the users and used to generate and or fine tune an interconnected device event response model for controlling smart devices in response to deviations from a user's daily schedule. Further, all data associated with user's daily schedule and smart device state can be stored in a secure location within a cloud database with the user's permission.

Smart device 112A, 112B, 112C can be a device capable of connecting to network 108 and can be controlled via device control engine 104. In this specification, state means the condition of a smart device. Some smart devices may have only 2 states (i.e., on or off), while others have a plurality of states (e.g., temperature on a thermostat, sensitivity of a motion detector, settings on a washing machine, lights on dimmers, etc. . . . ) In an embodiment, smart devices 112A, 112B, 112C are household appliances. For example, smart device 112A can be a thermostat, humidifier, light, electrical wall switch, television, coffee maker, dishwasher, washing machine, dryer, etc. It should be noted smart device is an all encompassing term for devices, systems, and appliances capable of being controlled via a network connection within a smart home or business. In some embodiments, smart devices 112A, 112B, 112C can have schedules that are preprogrammed or can be changed by a user or device control engine 104.

In some embodiments, smart device 112A, 112B, 112C can be a security system connected to network 108 or with Bluetooth® or NFC capabilities. The security system can have motion detectors, smart locks, window monitors, alarms, cameras, etc. The security system can be enabled or disabled by device control engine 104. For example, a user is 20 feet away from their front door and based on the location of user device 110, the smart device 112A, which is a smart lock at a front door, may unlock via device control engine 104, due to the proximity of user device 110. Smart device 112B, which is a smart lock at a back door stays locked, as it is only programmed to unlock unless the user device is detected 3 feet away from it (e.g., via NFC or Bluetooth®). In another example, user device 110 is detected in an upstairs room, this causes the cameras and motion detectors in the upstairs room and adjacent upstairs rooms to be disabled. Meanwhile, motion detectors and cameras in a basement and main entrance in the dwelling remain operational.

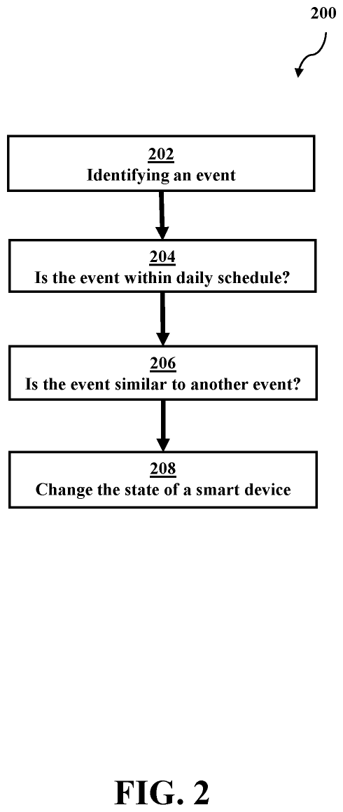

FIG. 2 is a flowchart depicting method 200 for event driven smart device control, in accordance with an embodiment of the present invention.

At step 202, device control engine 104 identifies an event based on the location of a user device 110, date, and time. In an embodiment, the location of user device 110 and additional factors can be entered into an interconnected device event response model on device control engine 104. The model can provide whether an event has occurred. In another embodiment, movement of user device 110 to another location will be the trigger at which an event is identified. Additionally, in some embodiments, if the location of user device 110 has not changed within a predetermined timeframe, an event is identified.

At step 204, device control engine 104 determines if the event is within the daily schedule. In an embodiment, device control engine 104 will compare the location data of user device 110 at the given time to that of the daily schedule. If the location data does not match, it is determined an event has occurred. In another embodiment, the location data of user device 110 will be fed into an interconnected device event response model to generate vector embeddings for the event. The embedding can be checked against the expected event for a generated daily schedule for the user.

At step 206, if it is determined the event is outside of the daily schedule, device control engine 104 will determine if there are any events similar to the identified event within historical event pool 106. Device control engine 104 will compare the location data against the location data expected for the time which the location data was provided. The compared location data associated with the daily schedule may be retrieved from historical event pool 106. In another embodiment, the vector embedding for the location data of user device 110 can be compared to the vector embeddings for prior events. A similarity score can be generated for the location data, and if the similarity score is above a predetermined threshold, the event is assigned to the similar event within historical event pool 106.

At step 208, device control engine 104 changes the state of a smart device. Once the received event is determined to be similar to another event within historical event pool 106, device control engine 104 can change the state of smart devices 112A, 112B, 112C to the same state as the similar event. In some embodiments, device control engine 104 can act as an orchestration layer and send a signal to change the state over network 108. In another embodiment, device control engine 104 can use the vector embeddings of the detected event as a timer and wait until the location data of user device 110 changes to send signal to smart devices 112A, 112B, 112C. For example, if a user is outside a specific geographical area, device control engine 104 will not change the state of a smart coffee maker to grind coffee beans and brew a pot of coffee. Additionally, if the user is outside a geographical area, a smart coffee maker may only brew half a pot of coffee, as in the determined similar event the user only brewed half a pot of coffee.

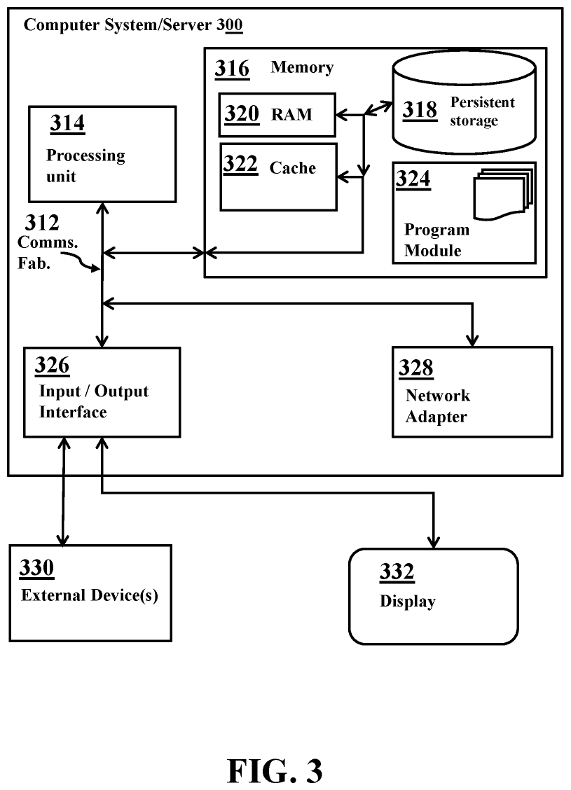

FIG. 3 depicts computer system 300, an example computer system representative of servers 102, user device 110, smart devices 112A, 112B, and 112C or any other computing device within an embodiment of the invention. Computer system 300 includes communications fabric 312, which provides communications between computer processor(s) 314, memory 316, persistent storage 318, network adaptor 328, and input/output (I/O) interface(s) 326. Communications fabric 312 can be implemented with any architecture designed for passing data and/or control information between processors (such as microprocessors, communications and network processors, etc.), system memory, peripheral devices, and any other hardware components within a system. For example, communications fabric 312 can be implemented with one or more buses.

Computer system 300 includes processors 314, cache 322, memory 316, network adaptor 328, input/output (I/O) interface(s) 326 and communications fabric 312. Communications fabric 312 provides communications between cache 322, memory 316, persistent storage 318, network adaptor 328, and input/output (I/O) interface(s) 326. Communications fabric 312 can be implemented with any architecture designed for passing data and/or control information between processors (such as microprocessors, communications and network processors, etc.), system memory, peripheral devices, and any other hardware components within a system. For example, communications fabric 312 can be implemented with one or more buses or a crossbar switch.

Memory 316 and persistent storage 318 are computer readable storage media. In this embodiment, memory 316 includes persistent storage 318, random access memory (RAM) 320, cache 322 and program module 324. In general, memory 316 can include any suitable volatile or non-volatile computer readable storage media. Cache 322 is a fast memory that enhances the performance of processors 314 by holding recently accessed data, and data near recently accessed data, from memory 316. As will be further depicted and described below, memory 316 may include at least one of program module 324 that is configured to carry out the functions of embodiments of the invention.

The program/utility, having at least one program module 324, may be stored in memory 316 by way of example, and not limiting, as well as an operating system, one or more application programs, other program modules, and program data. Each of the operating systems, one or more application programs, other program modules, and program data or some combination thereof, may include an implementation of a networking environment. Program module 324 generally carries out the functions and/or methodologies of embodiments of the invention, as described herein.

Program instructions and data used to practice embodiments of the present invention may be stored in persistent storage 318 and in memory 316 for execution by one or more of the respective processors 314 via cache 322. In an embodiment, persistent storage 318 includes a magnetic hard disk drive. Alternatively, or in addition to a magnetic hard disk drive, persistent storage 318 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 318 may also be removable. For example, a removable hard drive may be used for persistent storage 318. Other examples include optical and magnetic disks, thumb drives, and smart cards that are inserted into a drive for transfer onto another computer readable storage medium that is also part of persistent storage 318.

Network adaptor 328, in these examples, provides for communications with other data processing systems or devices. In these examples, network adaptor 328 includes one or more network interface cards. Network adaptor 328 may provide communications through the use of either or both physical and wireless communications links. Program instructions and data used to practice embodiments of the present invention may be downloaded to persistent storage 318 through network adaptor 328.

I/O interface(s) 326 allows for input and output of data with other devices that may be connected to each computer system. For example, I/O interface 326 may provide a connection to external devices 330 such as a keyboard, keypad, a touch screen, and/or some other suitable input device. External devices 330 can also include portable computer readable storage media such as, for example, thumb drives, portable optical or magnetic disks, and memory cards. Software and data used to practice embodiments of the present invention can be stored on such portable computer readable storage media and can be loaded onto persistent storage 318 via I/O interface(s) 326. I/O interface(s) 326 also connect to display 332.

Display 332 provides a mechanism to display data to a user and may be, for example, a computer monitor or virtual graphical user interface.

The components described herein are identified based upon the application for which they are implemented in a specific embodiment of the invention. However, it should be appreciated that any particular component nomenclature herein is used merely for convenience, and thus the invention should not be limited to use solely in any specific application identified and/or implied by such nomenclature.

The present invention may be a system, a method and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality and operation of possible implementations of systems, methods, and computer program products according to various embodiments of the present invention. In this regard, each block in the flowchart or block diagrams may represent a module, segment or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

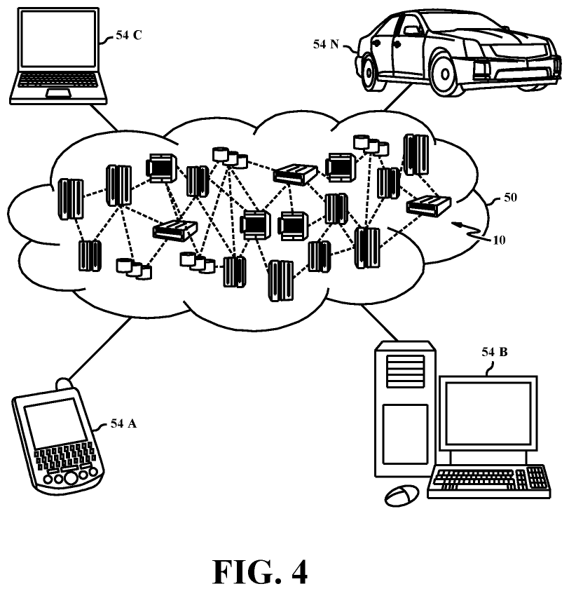

FIG. 4 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

FIG. 5 is a block diagram depicting a set of functional abstraction model layers provided by cloud computing environment 50 depicted in FIG. 4 in accordance with at least one embodiment of the present invention. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and event driven smart device control 96.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for changing a smart appliance state in response to detecting an event, the method comprising:
identifying, by a processor, an event based on at least location data associated with a user's device;
determining, by the processor, whether the event is outside of a user's daily schedule;
determining, by the processors, whether the event is similar to one or more prior events based on an interconnected device event response model;
responsive to the event being outside of the daily schedule and the event being similar to one or more prior events; and
changing, by the processors, a state of one or more smart appliances to a state corresponding to the one or more similar prior events.

2. The computer-implemented method of claim 1, further comprising:
training, by the processor, the interconnected device event response model.

3. The computer-implemented method of claim 2, wherein training the interconnected device event response model comprises:
receiving, by the processor, a user input, wherein the user input is associated with the user's daily schedule;
monitoring, by the processor, the location of the user's device;
identifying, by the processor, a plurality of daily events;
generating, by the processor, the user's daily schedule based on the plurality of identified events; and
generating, by the processor, a vector embedding corresponding to each one of the plurality of identified daily events.

4. The computer implemented method of claim 2, wherein the trained interconnected device event response model is a deep neural network.

5. The computer-implemented method of claim 1, further comprising:
receiving, by the processor, the location data associated with the user's device.

6. The computer-implemented method of claim 1, wherein determining whether the event is outside of the user's daily schedule is comprised of:
generating, by the processor, a distance difference score for the location data; and
determining, by the processor, if the distance difference score exceeds a distance threshold.

7. The computer implemented method of claim 1, wherein determining if the event is similar to the one or more prior events, comprises:
applying, by the processor, the event to a trained interconnected device event response model; and
generating, by the processor, a vector embedding for an identified event.

8. A computer system for changing a smart appliance state in response to detecting an event, the system comprising:
a memory; and
a processor in communication with the memory, the processor being configured to perform operations comprising:
identify an event based on at least location data associated with a user's device;
determine whether the event is outside of a user's daily schedule;
determine whether the event is similar to one or more prior events based on an interconnected device event response model;
responsive to the event being outside of the daily schedule and the event being similar to one or more prior events; and
change a state of one or more smart appliances to a state corresponding to the one or more similar prior events.

9. The computer system of claim 8, further comprising:
train the interconnected device event response model.

10. The computer system of claim 9, wherein training the interconnected device event response model comprises:
receive a user input, wherein the user input is associated with the user's daily schedule;
monitor the location of the user's device;
identify a plurality of daily events based on the user input and reoccurring user location activity;
generate the user's daily schedule based on the plurality of identified events; and
generate a vector embedding corresponding to each one of the plurality of identified daily events.

11. The computer system claim 9, wherein the trained interconnected device event response model is a deep neural network.

12. The computer system of claim 8, further comprising:
receive the location data associated with the user's device.

13. The computer system of claim 8, wherein determining whether the event is outside of the user's daily schedule is comprised of:
generate a distance difference score for the location data; and
determine if the distance difference score exceeds a distance threshold.

14. The computer system of claim 8, wherein determining if the event is similar to the one or more prior events, comprises:
apply the event to the trained interconnected device event response model; and
generate a vector embedding for an identified event.

15. A computer program product for changing a smart appliance state in response to detecting an event having program instructions embodied therewith, the program instructions executable by a processor to cause the processors to perform a function, the function comprising:
identify an event based on at least location data associated with a user's device;
determine whether the event is outside of a user's daily schedule;
determine whether the event is similar to one or more prior events based on an interconnected device event response model;
responsive to the event being outside of the daily schedule and the event being similar to one or more prior events; and
change a state of one or more smart appliances to a state corresponding to the one or more similar prior events.

16. The computer program product of claim 15, further comprising program instructions to:
train the interconnected device event response model.

17. The computer program product of claim 16, wherein training the interconnected device event response model comprises program instructions to:
receive a user input, wherein the user input is associated with the user's daily schedule;
monitor the location of the user's device;
identify a plurality of daily events based on the user input and reoccurring user location activity;
generate the user's daily schedule based on the plurality of identified events; and
generate a vector embedding corresponding to each one of the plurality of identified daily events.

18. The computer program product of claim 16, wherein the trained interconnected device event response model is a deep neural network.

19. The computer program product of claim 15, wherein determining whether the event is outside of the user's daily schedule is comprises program instructions to:
generate a distance difference score for the location data; and
determine if the distance difference score exceeds a distance threshold.

20. The computer program product of claim 15, wherein determining if the event is similar to the one or more prior events, comprises program instructions to:
apply the event to the trained interconnected device event response model; and
generate a vector embedding for an identified event.
